(19) United States
(12) Patent Application Publication
(10) Pub. No.: US 2009/0079901 A1
(43) Pub. Date: Mar. 26, 2009

(54) Liquid crystal display device

(75) Inventors: Haruyoshi Yada, Kawasaki (JP); Miyuki Kazama, Kawasaki (JP); Toshifumi Tanida, Kawasaki (JP); Nariyasu Hayakawa, Kawasaki (JP); Hiroshi Kobayashi, Kawasaki (JP); Toshiyuki Itoh, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/230,996

(22) Filed: Sep. 9, 2008

(30) Foreign Application Priority Data
Sep. 25, 2007 (JP) 2007-247321

(51) Int. Cl. G02F 1/1333

(52) U.S. Cl. 349/58

(57) ABSTRACT

Provided is a liquid crystal display device, including a liquid crystal display panel, a liquid crystal display protection panel protecting a display surface of the liquid crystal display panel, and a frame supporting the liquid crystal display protection panel on a periphery of a surface of the liquid crystal display protection panel, wherein a gap is installed between a edge surrounding the liquid crystal display protection panel and the frame.

### TECHNICAL FIELD

It relates to a liquid crystal display device. In particular, it relates to a liquid crystal display device such as a portable information terminal, which is equipped with a liquid crystal display device including a liquid crystal display (LCD) protection panel and a liquid crystal module including a liquid crystal display (LCD) panel.

Liquid crystal display devices have been widely used for display units of various electronic devices such as a portable information terminal such as a cell phone or a PDA (personal digital assistants), a portable PC (personal computer) such as a laptop PC, a desktop PC, and a television on account of being thin and lightweight as well as because of low-voltage driving and power-saving.

FIG. 1 is a front view of a conventional cell phone equipped with a liquid crystal display device.

A cell phone 10 of FIG. 1 includes a stationary-side case 1 and a movable-side case 3 coupled with the stationary-side case 1 through a hinge 2 in a foldable manner. In the illustrated example of FIG. 1, the movable-side case 3 of the cell phone 10 is opened.

The stationary-side case 1 has a flat, substantially rectangular shape. An inner surface 4 of the stationary-side case 1 is provided with, for example, plural push buttons 5, 6, and 7. Further, an inner surface 8 of the movable-side case 3 is provided with, for example, a liquid crystal display device 9.

FIG. 2 is a cross-sectional view of the liquid crystal display device 9 of FIG. 1.

As shown in FIG. 2, the liquid crystal display device 9 includes a front case 11, a rear case 12, and an LCD (liquid crystal display) protection panel 13.

The front case 11 is a molded case made of a resin or magnesium alloy, for example. A lower surface of the front case 11 is bonded to an upper end of the rear case 12 by means of claws or screws.

A liquid crystal display protection panel mounting surface 11a extends from an upper portion of the front case 11. The LCD protection panel 13 made of polymethyl methacrylate (PMMA) as an acrylic polymer is placed on the liquid crystal display protection panel mounting surface 11a through a double-faced adhesive tape 14, for example.

FIG. 3 is an enlarged view of a portion A enclosed by the dotted line of FIG. 2. As shown in FIG. 3, the liquid crystal display protection panel mounting surface 11a is a flat surface substantially parallel to the horizontal. An outer edge of the LCD protection panel 13 is fixed onto the liquid crystal display protection panel mounting surface 11a by means of the double-faced adhesive tape 14. Further, there is no space but a small gap resulting from dimensional tolerances, between an end face of the LCD protection panel 13 and an inner surface of the upper portion of the front case 11.

Referring back to FIG. 2, a concave liquid crystal module holder 16 having a substrate 15 attached to the bottom is provided inside the front case 11. Electronic components such as a chip capacitor are mounted onto the substrate 15 but are not illustrated in FIG. 2. Liquid crystal modules 17 and 18 are nested into the concave portion of the liquid crystal module holder 16. By the way, the liquid crystal module 18 is a liquid crystal display (LCD) panel, and the liquid crystal module 17 is a LCD panel holder for holding the LCD panel 18.

An upper edge of the liquid crystal module holder 16 is in contact with a lower side of the upper portion of the front case 11. The liquid crystal module holder 16 supports the front case 11. Further, a dustproof gasket 19 made of cushioning such as urethane form rubber is put on an upper edge of the LCD panel 18. The dustproof gasket 19 is in contact with a lower surface of the LCD protection panel 13. This structure protects the liquid crystal modules 17 and 18 from powder dust.

In addition, Japanese Laid-open Patent Publication No. 2004-111153 proposes a backlight and a liquid crystal display device, which include a light source supporting member for supporting a light source to a chassis or a corner portion of a light reflecting member, and in which a reflector is partially positioned between the chassis and the light source supporting member, and the light source supporting member controls movement of a front edge portion of the reflector relative to the chassis in a direction parallel to a front side of a light guide.

However, the structure of FIG. 2 involves the following problems. Referring to cross-sectional views of FIGS. 4A and 4B similar to FIG. 2, the problems are described below.

The LCD protection panel 13 tends to expand in the direction of the arrow of FIG. 4A due to temperature rise or moisture absorption. How much the LCD protection panel 13 extends due to the expansion resulting from moisture absorption varies depending on water absorption, a panel thickness, etc. If the LCD protection panel 13 is made of, for example, polymethyl methacrylate (PMMA) as an acrylic polymer, the water absorption is 0.3%.

On the other hand, as described above, the outer edge of the lower surface of the LCD protection panel 13 is fixed onto the liquid crystal display protection panel mounting surface 11a through the double-faced adhesive tape 14. Further, there is no space but a small gap resulting from dimensional tolerances, between the end face of the LCD panel protection 13 and the inner surface of the upper portion of the front case 11.

Therefore, although the LCD protection panel 13 tends to expand due to temperature rise or moisture absorption, the extension in a horizontal direction (direction of the arrow of FIG. 4A) resulting from the expansion is restricted.

As a result, as shown in FIG. 4B, the LCD protection panel 13 warps inwardly (downwardly in FIG. 4B) according to the expansion, and the lower surface of the LCD protection panel 13 comes into contact (interferes) with the upper surface of the LCD panel 18 in some cases. If the lower surface of the LCD protection panel 13 comes into contact with the upper surface of the LCD panel 18, the contact portion looks like a droplet infiltrated in a space between the LCD protection panel 13 and LCD panel 18. As a result, there is no choice but to repair the liquid crystal display device 9.

One conceivable countermeasure against such a problem is to secure enough space between the lower surface of the LCD protection panel 13 and the upper surface of the LCD panel 18 not to bring the lower surface of the LCD protection panel 13 and the upper surface of the LCD panel 18 into contact with each other even if the LCD protection panel 13 expands. However, this structure leads to enlargement of the liquid crystal display device 9 and thus the cell phone 10.

### SUMMARY

According to an aspect of an embodiment, a liquid crystal device comprises a liquid crystal display panel, a liquid crystal display protection panel protecting a display surface of the liquid crystal display panel, and a frame supporting the liquid crystal display protection panel on a periphery of a surface of the liquid crystal display protection panel, wherein a gap is installed between a edge surrounding the liquid crystal display protection panel and the frame.

### BRIEF DESCRIPTION OF THE DRAWINGS

FIG. 1 is a front view of a conventional cell phone equipped with a liquid crystal display device;

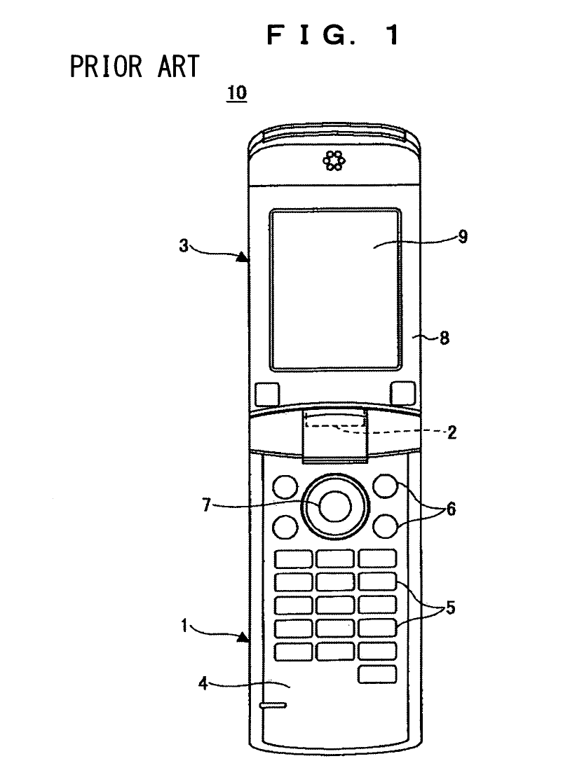

FIG. 2 is a cross-sectional view of the liquid crystal display device of FIG. 1;

FIG. 3 is an enlarged view of a portion A enclosed by the dotted line of FIG. 2;

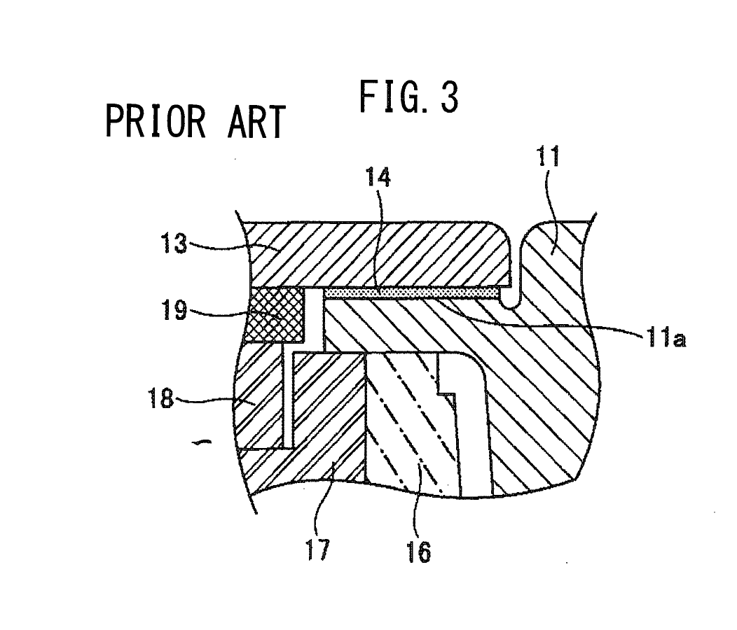

FIGS. 4A and 4B are sectional views illustrating problems of the conventional liquid crystal display device;

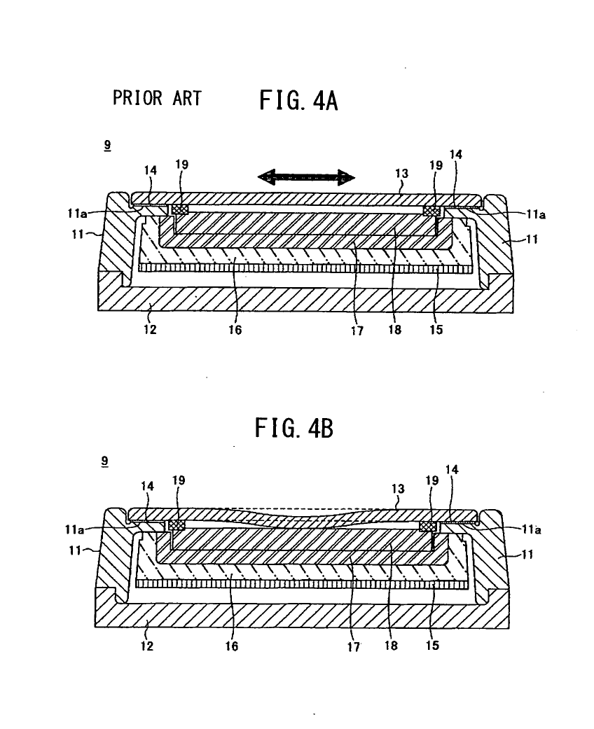

FIG. 5 is a perspective view of a cell phone equipped with a liquid crystal display device according to a first embodiment;

FIG. 6 is a cross-sectional view of the liquid crystal display device of FIG. 5;

FIGS. 7A and 7B show how a liquid crystal display protection panel of FIG. 6 expands; and

FIG. 8 is an enlarged view of a modified example of a portion A enclosed by the dotted line of FIG. 6.

### DESCRIPTION OF THE PREFERRED EMBODIMENTS

Hereinafter, embodiments will be described.

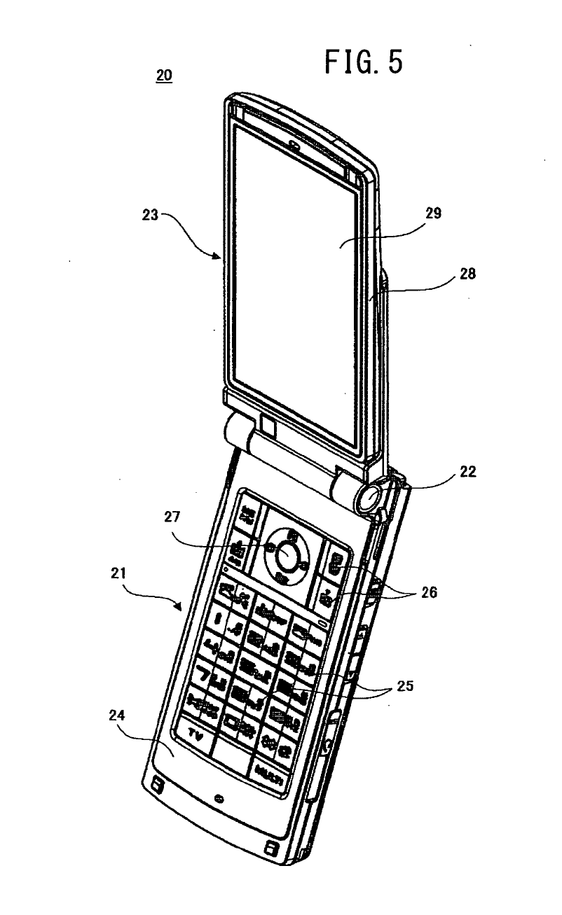

FIG. 5 is a perspective view of a cell phone equipped with a liquid crystal display device according to a first embodiment.

A cell phone 20 of FIG. 5 includes a stationary-side case 21 and a movable-side case 23 coupled with the stationary-side case 21 through a hinge 22 in a foldable manner. In the illustrated example of FIG. 5, the movable-side case 23 of the cell phone 20 is opened.

The stationary-side case 21 has a flat, substantially rectangular shape. An inner surface 24 of the stationary-side case 21 is provided with, for example, plural push buttons 25, 26, and 27. Further, an inner surface 28 of the movable-side case 23 is provided with, for example, a liquid crystal display device 29.

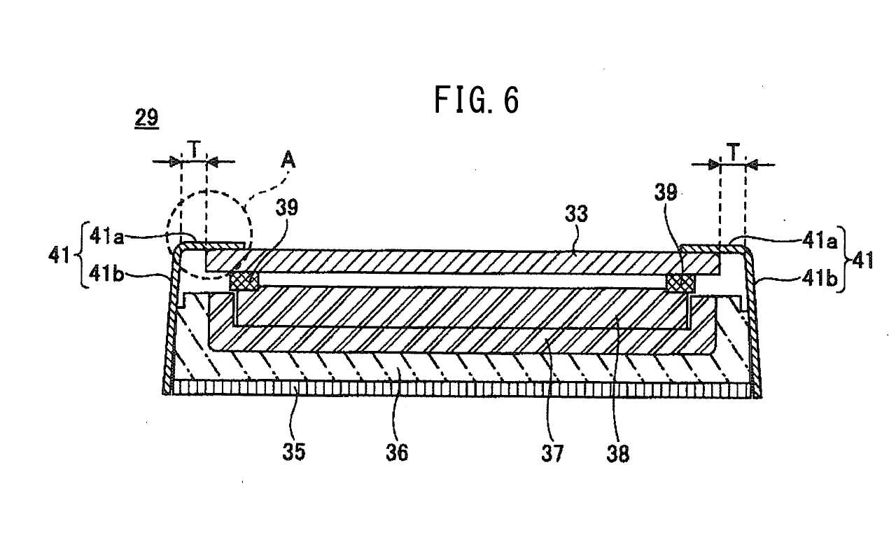

FIG. 6 is a cross-sectional view of the liquid crystal display device 29 of FIG. 5.

As shown in FIG. 6, the liquid crystal display device 29 includes an LCD (liquid crystal display) protection panel 33, a frame 41 as a plate-like member bent at substantially right angle, a substrate 35, a liquid crystal module holder 36, liquid crystal modules 37 and 38 nested into a concave portion of the liquid crystal module holder 36, and a dustproof gasket 39. By the way, the liquid crystal module 38 is a liquid crystal display (LCD) panel, and the liquid crystal module 37 is a LCD panel holder for holding the LCD panel 38.

The LCD protection panel 33 is a panel for protecting a display surface of LCD panel 38, and made of, for example, polymethyl methacrylate (PMMA) as an acrylic polymer.

The frame 41 is composed of a liquid crystal display protection panel contact portion 41a and a holder connection portion 41b extending from the liquid crystal display protection panel contact portion 41a and bent at substantially right angel to the liquid crystal display protection panel contact portion 41a. The liquid crystal display protection panel contact portion 41a is positioned over both ends of an upper surface of the LCD protection panel 33 and the vicinities thereof. The holder connection portion 41b is connected to the liquid crystal module holder 36 through engagement of claws (not shown) with holes (not shown) formed in the holder connection portion 41b, the claws being formed in corresponding positions on the liquid crystal module holder 36. That is, the frame 41 presses the upper surface of the LCD protection panel 33 from above the LCD protection panel 33 while being connected to the liquid crystal module holder 36.

As described below in detail, both ends of the LCD protection panel 33 are positioned away from the inner surface of the holder connection portion 41b of the frame 41 by a predetermined length, for example, 0.2 mm. There is a gap T between the end portion of the LCD protection panel 33 and the inner surface of the holder connection portion 41b of the frame 41.

The thus-structured frame 41 is made of, for example, stainless steel (SAS). If a stainless steel (SAS)-made plate-like member is used for the frame 41, the total thickness of the device can be reduced. Here, as long as the frame can press the upper surface of the LCD protection panel 33 from above the LCD protection panel 33, a material for the frame 41 is not particularly limited. For example, a resin or magnesium alloy may be molded into the frame 41. Further, it is possible to mold a resin or magnesium alloy into an armor and cover the frame 41 with the armor.

The concave liquid crystal module holder 36 having a substrate 35 attached to the bottom is provided below the LCD protection panel 33. The liquid crystal module holder 36 is made of, for example, stainless steel (SAS). Here, a material for the liquid crystal module holder 36 is not particularly limited, and a resin or magnesium alloy may be molded into the liquid crystal module holder 36.

Electronic components such as a chip capacitor are mounted onto the substrate 35 but are not illustrated in FIG. 6. The liquid crystal modules 37 and 38 are nested into the concave portion of the liquid crystal module holder 36.

The dustproof gasket 39 made of cushioning such as urethane form rubber is put on an upper edge of the LCD panel 38. The dustproof gasket 39 is in contact with a lower surface of the LCD protection panel 33 and supports the lower surface of the LCD protection panel 33. This structure protects the liquid crystal modules 37 and 38 from powder dust.

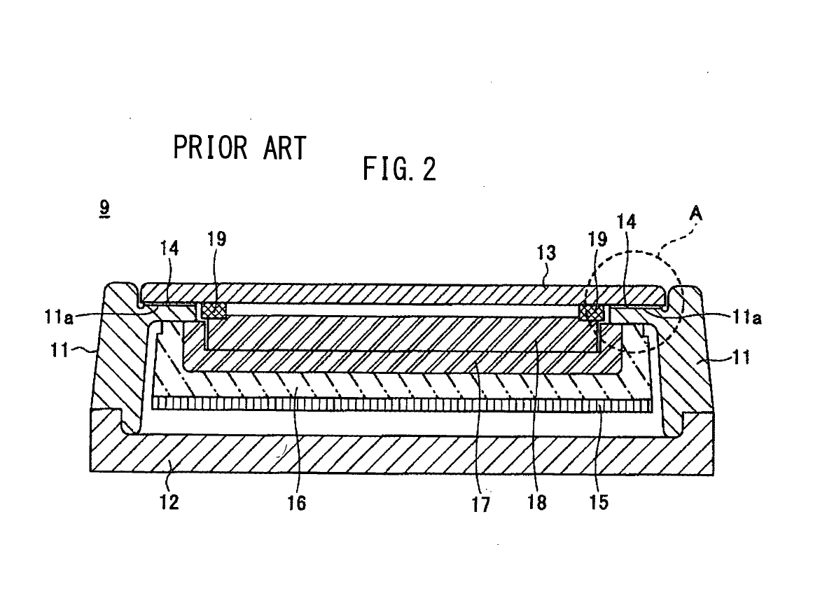

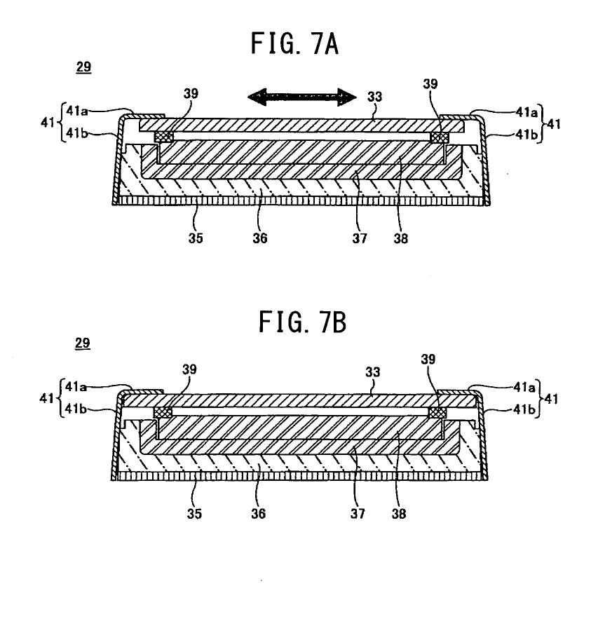

The thus-structured LCD protection panel 33 tends to expand in the direction of the arrow of FIG. 7A due to temperature rise or moisture absorption. FIGS. 7A and 7B are sectional views similar to FIG. 6. The outer edge of the lower surface of the LCD protection panel 33 is not fixed by a double-faced adhesive tape 14 (see FIG. 2), and both ends of the LCD protection panel 33 are away from the inner surface of the holder connection portion 41b of the frame 41, so the extension of the LCD protection panel 33 in a horizontal direction (direction of the arrow of FIG. 7A) is not restricted. Accordingly, this expansion can be absorbed in a planar direction, and the LCD protection panel 33 does not warp even if expanded.

In other words, the gap T between the end portion of the LCD protection panel 33 and the inner surface of the holder connection portion 41b of the frame 41 is large enough to keep a space between the end portion of the LCD protection panel 33 and the inner surface of the holder connection portion 41b of the frame 41 even after the LCD protection panel 33 expands in a horizontal direction (direction of the arrow of FIG. 7A). Thus, even if the LCD protection panel 33 expands, the degree of freedom of extension in a width direction of the LCD protection panel 33 is secured, so the end portions of the expanded LCD protection panel can extend in the width direction (direction of the arrow of FIG. 7A).

As described above, in this embodiment, the device is structured such that the gap T is defined between the end portion of the LCD protection panel 33 and the inner surface of the holder connection portion 41b of the frame 41, the dustproof gasket 39 supports the lower surface of the LCD protection panel 33, and the liquid crystal display protection panel contact portion 41a of the frame 41 presses the upper surface of the LCD protection panel 33.

With this structure, the LCD protection panel 33 does not warp even if expanded. Hence, it is possible to keep the lower surface of the LCD protection panel 33 from contact (interfering) with the upper surface of the LCD panel 38.

Further, since the LCD protection panel 33 does not warp even if expanded, it is unnecessary to increase a gap S between the lower surface of the LCD protection panel 33 and the upper surface of the LCD panel 38. Hence, it is unnecessary to enlarge the liquid crystal display device 29 and the cell phone 20.

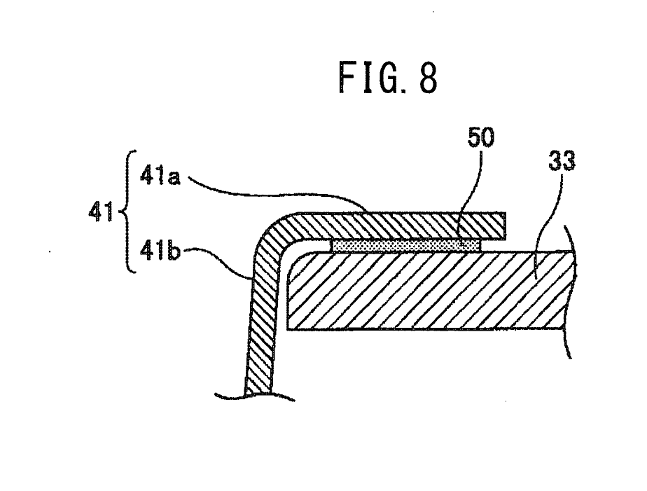

In the illustrated example of FIG. 6, the liquid crystal display protection panel contact portion 41a of the frame 41 is directly placed over both ends of the upper surface of the LCD protection panel 33 and the vicinities thereof. However, this embodiment is not limited thereto, and the structure of FIG. 8 may be employed. FIG. 8 is an enlarged view of a modified example of the portion A enclosed by the dotted line of FIG. 6.

In FIG. 8, for example, the liquid crystal display protection panel contact portion 41a of the frame 41 is placed over both ends of the upper surface of the LCD protection panel 33 and the vicinities thereof through a dustproof member 50.

A one-sided adhesive tape or cushioning may be used as the dustproof member 50. By inserting the dustproof member 50 between the liquid crystal display protection panel contact portion 41a of the frame 41 and the LCD protection panel 33, intrusion of power dust from the outside can be surely prevented. Further, if a one-sided adhesive tape or cushioning is used as the dustproof member 50, for example, the following advantages can be attained in addition to the dustproof effect. That is, even if the LCD protection panel 33 expands, the extension of the LCD protection panel 33 in a horizontal direction (direction of the arrow of FIG. 7A) is not restricted, and the LCD protection panel 33 can be prevented from warping.

As described above, according to the structure of this embodiment, the lower surface of the LCD protection panel 33 can be kept from contact (interfering) with the upper surface of the LCD panel 38. Thus, it is possible to avoid a phenomenon that looks as if a droplet infiltrates in between the LCD protection panel 33 and the LCD panel 38 can be avoided without increasing the gap between the lower surface of the LCD protection panel 33 and the upper surface of the LCD panel 38.

The liquid crystal display device 29 is illustrated in FIG. 6 in cross-section. However, this structure is also applicable to the longitudinal-section structure of the liquid crystal display device 29.

The embodiments are described in detail above. However, the present invention is not limited to the above embodiments but could be modified and changed without departing from the scope of the invention.

For example, the above embodiments of the present invention describe the liquid crystal display device in the cell phone for illustrative purposes, but the present invention is also applicable to a liquid crystal display device in other electronic devices such as a portable information terminal such as a PDA (personal digital assistants), a portable PC (personal computer) such as a laptop PC, a desktop PC, and a television.

What is claimed is:

1. A liquid crystal display device comprising:
a liquid crystal display panel;
a liquid crystal display protection panel protecting a display surface of the liquid crystal display panel; and
a frame supporting the liquid crystal display protection panel on a periphery of a surface of the liquid crystal display protection panel,
wherein a gap is installed between a edge surrounding the liquid crystal display protection panel and the frame.

2. The liquid crystal display device according to claim 1,
wherein the frame comprises a protection panel contact portion contacting with the surrounding part on the surface of the liquid crystal display protection panel, and a holder connection port having a connecting port to a holder keeping the liquid crystal display panel, the holder connection port being bent to the supported liquid crystal display protection panel side for the protection panel contact portion,
wherein a gap is installed between a edge surrounding the liquid crystal display protection panel and the holder connection port, the liquid crystal display protection panel is supported by holding the surface of the liquid crystal display protection panel with the frame.

3. A liquid crystal display device comprising:
a liquid crystal display panel;
a liquid crystal display protection panel protecting a display surface of the liquid crystal display panel;
a gasket placed on a surrounding part of an other side of a surface of the liquid crystal display protection panel;
the liquid crystal display panel contacting with the gasket on a surface of the liquid crystal display panel, installed under the liquid crystal display protection panel;
a liquid crystal display panel holder holding the liquid crystal display panel; and
a frame having a protection panel contact portion contacting with the surrounding part on the surface of the liquid crystal display protection panel, and a holder connection port having a connecting port to a holder keeping the liquid crystal display panel, the holder connection port being bent to the supported liquid crystal display protection panel side for the protection panel contact portion, the frame holding the liquid crystal display protection panel at the protection panel contact portion,
wherein a gap is installed between a edge surrounding the liquid crystal display protection panel and the holder connection port, the liquid crystal display protection panel is supported by holding the surface of the liquid crystal display protection panel with the frame, by holding the other surface of the liquid crystal display protection panel with the gasket.

4. The liquid crystal display device according to claim 3, further comprising:
a dustproof gasket installed between a surrounding part of the display surface of the liquid crystal display panel and the protection panel contact portion so as to prevent a dust from adhering to the liquid crystal display panel.

5. The liquid crystal display device according to claim 4,
wherein the dustproof gasket is a cushioning.

6. The liquid crystal display device according to claim 4,
wherein the dustproof gasket is glued onto each of the liquid crystal display protection panel and the protection panel contact portion with an adhesive tape.

7. The liquid crystal display device according to claim 1, wherein the gap is 0.2 mm or more.
